(19) United States
(12) Patent Application Publication
(10) Pub. No.: US 2011/0302836 A1
(43) Pub. Date: Dec. 15, 2011

(54) METHOD FOR THE CULTIVATION, CONSERVATION, MAINTENANCE AND EXPRESS INSTALLATION OF LAWN IN GREENHOUSES OR INDOORS FOR A NATURAL GRASS MAT

(76) Inventor: Mario Alberto, Decima Region (CL)

(21) Appl. No.: 12/737,035

(22) PCT Filed: Jun. 9, 2009
(86) PCT No.: PCT/IB2009/006713

§ 371 Date: Aug. 29, 2011

(30) Foreign Application Priority Data
Jun. 10, 2008 (CL) 07104-2008

(51) Int. Cl. A01G 1/00

(52) U.S. Cl. 47/58.1 SC

(57) ABSTRACT

The present invention pertains to a method for the cultivation, conservation, maintenance and installation of prado express in greenhouses or closed premises to obtain natural grass carpets in less time and with a better quality, destined to cover private and public areas in general in a fast, easy and economic way.

The present invention pertains to a method for the cultivation, conservation, maintenance and installation of lawn express in greenhouses or closed premises to obtain natural grass carpets in less time and with a better quality, destined to cover private and public areas in general in a fast, easy and economic way.

Regarding the state of the art, we can mention the patent ES No. 2.178.578, which claims for a procedure to obtain a transplantable vegetal layer which characterizes for including the following stages:

a) Arrangement of a flexible reticular laminate support over a non-porous surface;
b) Then, coverage of the laminate support with an organic cultivation substrate for the germination of seeds.
c) Distribution of the seed corresponding to the vegetable to be obtained from the support.
d) Maintenance of humidity conditions in the cultivation substrate in order to ensure the germination, root-taking and growth of vegetation until the desired height or density is reached; and
e) Separation of such layer from the non-porous surface in order to transplant it over the surface to be covered.

Claim No. 2, characterizes the reticular laminate support, which describes a tissue or grid based on organic or natural fibers.

Another invention patent is ES No. 2.216.714, which claims for a base-layer for supporting grass surfaces consisting on a mix of organic or vegetable compost (3) and rubber granules (2) obtained from the recycling of automotive tires or rubber tires to be determined over a removed substrate or soil a support layer (1) to plant grass (5) which is covered for a fine layer of organic or vegetal compost (4), determining the layer or base layer (1) a buffering mean and drainage for the grass surface.

Regarding the current state of the art, it is possible to find three types of cultivation and installation of grass, both for homes or in great extensions such as parks or sport fields, among others.

1.—Direct Planting: The first type includes direct plating in the desired location. This activity has shown to require certain basic knowledge and specially, perseverance in care. The normal process of installation of grass by plating (recommended by ANASAC) is performed in the following way:
a) Crush: crush the soil at a 20 to 30 depth [cm].
b) Filter: filter the soil with a sieve to remove stones and clods.
c) Improvement of Soil: distribute a 2 to 3 [cm] layer of vegetal soil along with a part of fertilizer.
d) Level: rake the land in order to level it and add the soil and fertilizer to the ground trying to keep it as even as possible.
e) Compactation: gently compact the ground with a roller or tamper.
f) Sow: uniformly distribute the seed in the dose recommended in the container randomly or with a sowing machine.
g) Cover Seed: cover the seed with a layer of vegetable soil.
h) Compactation: gently compact the already sown ground with a roller or tamper.
i) Irrigation: irrigate in the form of a fine rain, not allowing the ground to dry the first 25 days in order to ensure a good establishment.
j) Cut: perform the first cut when the grass reaches an 8 to 10 [cm] height, leaving it at a 4 to 5 height [cm].

This type of installation requires an extreme care to avoid the lost of the seed and also to achieve a homogeneous growth of the grass and it also requires an average of 4 to 6 months to grow an optimum grass.

### 2.—Lawn Turf:

The second type of installation of grass includes the use of lawn turf also called turf. This lawn turfs corresponds to a rectangle of grass with standard measures of 0.5 [m]×1 [m] with a 2.5 to 4 [cm] layer of soil (See FIG. 9). Lawn turfs are extracted through cuts from natural grounds or fields specially sown for this activity.

The installation of lawn turfs is more expensive than planting but it has the advantage to be easily located in any time of the year both for covering broad areas and to repair small areas. Grass planted with turfs is more uniform and have less risk of diseases and weed.

Installation of Turfs: The normal process of installation of lawn turfs (as recommended by HOMECENTER) is the following one:
a) Crush: crush the soil at a 10 depth [cm].
b) Filter: filter the soil with a sieve to remove stones and clods.
c) Improvement of Soil: distribute a 2 to 3 [cm] layer of vegetal soil along with a part of fertilizer.
d) Level: rake the land in order to level it and add the soil and fertilizer to the ground trying to keep it as even as possible.
e) Compactation: gently compact the ground with a roller or tamper.
f) Irrigation: irrigate and slightly humidify the ground the day before starting the installation of the turfs.
g) Installation: perform the installation of turfs in lines by pressing the surface in order to make the roots contact the soil.
h) Compactation: gently compact the already sown ground with a roller or tamper.
i) Seal: spread a layer of sand or peat in the spaces that could have been left uncovered in the joints in order to seal them.
j) Fertilizing: in order to stimulate the growth of new roots and the recovery of the existent ones, apply a fertilizer rich in nitrogen and phosphorus.
k) Irrigation: irrigate in the form of a fine rain, not allowing the ground to dry the first 20 days in order to ensure a good establishment.
l) Cut: perform the first cut when the grass reaches an 8 to 10 [cm] height, leaving it at a 4 to 5 height [cm].

It is worth to mention that in this type of installation, the lawn turfs must not be fit by pressing them because they can lose form. Besides, after installing the lawn turfs, the grass can be used immediately, but it is better not to use it in an intensive way in the following two months.

Productive Turf System: From a productive point of view, turfs can be obtained in two forms:
a) Natural Grasslands: where producers extract turfs and grass grows naturally. It is a regular practice to pay the owners for the soils destined to extraction purposes.
b) Sowing: producers seed large extensions of soil where turfs are obtained from. In this case the productive process is the sowing process already described. It is worth to mention that it is a common practice to rent fields for the production and to perform 2 average cuts every year at a ±4 [cm] depth, with a loss of 1,000 tons/ha a year and provoke the degradation of soil which translates into a low sustainability of this production and any other later agricultural activityⁱ. The rented field is used until the soil loses its capacities and productive potential and then the production is transferred to new fields.
3.—Turf Roll: the third type of installation considers using turf rolls with the same characteristics of lawn turfs but different mainly in measures, uses and target market. These rolls (see FIG. 11) correspond to a rectangle of grass with standard measures. The medium size roll is 0.75 [m]×15 [m] and the large roll is 0.75 [m]×33 [m]. In both cases, thickness is 2.5 to 4 [cm].
Installation of Rolls: The normal process of installation of these rolls is similar to that of turfs, different mainly in the use of special machines such as tractors; skimming shovels and sewing machines (see FIGS. 12 and 13). It is worth to mention that after installing the rolls, grass can be used immediately although an intensive use is not convenient until a month has passed.
c) Productive System of Rolls: From a productive point of view, rolls are extracted from fields sown specially for this activity. In this case the productive process is the one already described for the plating of grass. It is worth to mention, that like in the case or turfs, the normal practice is to rent fields for the production until the soil loses its capacities and productive potential and then the production is transferred to new fields.

### Technical Comparison Prado Express v/s Competition

Differentiating elements of Prado Express that establish their advantages over the competition come from a comparison among the different types of grass sewing available in the domestic market.
Table 3 resumes the comparison of technical characteristics between Prado Express and Direct Sewing, Lawn Turf and Turf Rolls:

TABLE 3
Comparative Matrix between Prado Express v/s Competition

| Characteristics | Sewing | Turf | Roll | Prado Express |
|---|---|---|---|---|
| Measures | The necessary | Standard area 0.5 [m] × | Medium size roll: | Variable width and length. |
| | extension is sown | 1 [m] | Standard area 0.75 [m] × | 2 [cm] thick |
| | | 2.5 to 4 [cm] thick | 15 [m] | |
| | | | Large Roll: Standard | |
| | | | area 0.75 [m] × 33 [m] | |
| | | | 2.5 to 4 [cm] thick | |
| Weight | Does not correspond | 17 [Kg] by every 1 m² | 17 [Kg] by every 1 m² | 3.5 [Kg] by every 1 m² average |
| | | average | average | |
| Substrate | Field where the sewing | Layer of soil from the | Layer of soil from | Layer of sawdust |
| | process is performed | ground where the turf was | the ground where the roll | |
| | | obtained | was obtained | |
| Roots | Inserted in the field | Inserted in the substrate | Inserted in the | Under the substrate layer |
| | where the sewing process is | layer | substrate layer | Intact roots |
| | performed | Cut roots | Cut roots | It does not require recovery period |
| | | It requires recovery | It requires recovery | |
| | | period | period | |
| Type of lawn | It depends on the sewing | Natural grass obtained | California Mix: mix | Tehnisan Mix: High resistance |
| | process | from grasslands. | of Festuca and Ballica, a | mix specially developed for intensive |
| | | California Mix: mix of | little bit thicker than | use places. |
| | | Festuca and Ballica, a little | common grass. It is a high | |
| | | bit thick than common grass. | transit grass that remains | |
| | | It is a high transit grass that | green all the year. | |
| | | remains green all the year. | Small Bermuda | |
| | | Small Bermuda | (hybrid): Highly resistant | |
| | | (hybrid): Highly resistant | and easy to maintain but | |
| | | and easy to maintain but | with a period of winter | |
| | | with a period of winter | dormancy when grass | |
| | | dormancy when grass turns | turns into a yellow color. | |
| | | into a yellow color. | Golf: Ballica Perenne, | |
| | | Golf: Ballica Perenne, | High Festucas and Fine | |
| | | High Festucas and Fine | Festucas. | |
| | | Festucas. Green all year, it | Green all year, it requires | |
| | | requires frequent watering. | frequent watering. It | |
| | | It tolerates transit very well. | tolerates transit very well. | |
| | | It is ideal for small and | It is ideal for small and | |
| | | medium size gardens. | medium size gardens. It | |
| | | It behaves regularly in very | behaves regularly in very | |
| | | dark areas. | dark areas. | |
| Incorporation | It adds weeds | It incorporates weeds | It incorporates weeds | It does not add weed because it |
| of weed | | because of being extracted | because the production is | is produced in greenhouses |
| | | from natural grasslawns of | performed in open fields | |
| | | because the production is | | |
| | | performed in open fields | | |
| Incorporation | It adds black cutworm | It adds cutworm in the | It adds cutworm in | It does not add cutworm in the |
| of Black | if it exists in the ground | substrate if turf comes from | the substrate if the roll | substrate |
| Cutworm | | infected fields | comes from infected fields | |
| Distribution of | Non-uniform | Uniform distribution | Uniform distribution | Uniform distribution without |
| lawn | distribution | with blank spaces | with blank spaces | blank spaces |
| Color tone | Yellowish to dark | Yellowish to dark | Yellowish to dark | Dark green all year |
| | green depending on the | green depending on the time, | green depending on the | |
| | sewing time and | type of mix and if it comes | time and type of mix | |
| | maintenance care | from grasslawns or sewing | | |
| Process of | It requires: | It requires | It requires | It requires: |
| Installation | 1. Crush | 1. Crush | 1. Crush | 1. Level up |
| | 2. Filter | 2. Filter | 2. Filter | 2. Fertilizing process |
| | 3. Improve Field | 3. Improve Field | 3. Improve Field | 3. Installation |
| | 4. Level up | 4. Level up | 4. Level up | 4. Fertilizing process |
| | 5. Compactation | 5. Compactation | 5. Compactation | 5. Watering |
| | 6. Sewing | 6. Watering | 6. Watering | 6. Cut |
| | 7. Cover Seeds | 7. Installation | 7. Installation | |
| | 8. Compactation | 8. Compactation | 8. Compactation | |
| | 9. Watering | 9. Sealing process | 9. Sealing process | |
| | 10. Cut | 10. Fertilizing process | 10. Fertilizing process | |
| | | 11. Watering | 11. Watering | |
| | | 12. Cut | 12. Cut | |
| Installation | It requires a field rich | It requires a field rich | It requires a field rich | It does not requires a field rich |
| field | in organic matter | in organic matter | in organic matter | in organic matter |
| Waiting period | 6 months | 2 weeks for low transit | 2 weeks for low | 2 weeks for high transit |
| for high transit | | 2 months for high | transit | |
| | | transit | 1 month for high | |
| | | | transit | |
| Maintenance | Do not stand on the | Frequent watering | Frequent watering | Frequent watering |
| during | sown grass | Use of fertilizers to | Use of fertilizers to | Use of fertilizers, just as |
| installation | New sewing where the | stimulate the recovery of cut | stimulate the recovery of | recommendation to stimulate the |
| | seed does not germinate, it | roots and growth of lawn | cut roots and growth of | growth of lawn |
| | was moved because of | | lawn | |
| | watering or it has been | | | |
| | eaten by birds | | | |
| | Frequent watering | | | |
| | Use of fertilizers | | | |
| Productive | It requires: | It requires: | It requires: | It requires: |
| Process | 1. Crush | 1. Crush | 1. Crush | 1. Prepare Field |
| | 2. Filter | 2. Filter | 2. Filter | 2. Sewing |
| | 3. Improve Field | 3. Improve Field | 3. Improve Field | 3. Watering |
| | 4. Level up | 4. Level up | 4. Level up | 4. Maintenance |
| | 5. Compactation | 5. Compactation | 5. Compactation | 5. Cut |
| | 6. Sewing | 6. Sewing | 6. Sewing | 6. Harvest |
| | 7. Cover Seeds | 7. Cover Seeds | 7. Cover Seeds | |
| | 8. Compactation | 8. Compactation | 8. Compactation | |
| | 9. Watering | 9. Watering | 9. Watering | |
| | 10. Cut | 10. Cut | 10. Cut | |
| | | 11. Harvest | 11. Harvest | |
| Resistance to | It does not correspond | It maintains color for 5 | It maintains color for | It maintains color for 10 days |
| storing | | days | 5 days | |
| Transportation | It does not correspond | It is performed mainly | It is performed | It can be performed with both |
| | | with dry turfs | mainly with dry rolls | dry and wet carpets |
| | | Extreme care must be | Extreme care must | High resistance carpet that does |
| | | put on not breaking the turf, | be put on not breaking the | not break with the transportation even |
| | | especially if it is wet | roll, especially if it is wet | when it is wet |
| | | Particular vehicles to | It requires trucks and | Particular vehicles to trucks can |
| | | trucks can be used | special machines such as | be used depending on the quantity |
| | | depending on the quantity | tractors, forklifts, etc. | |
| Time of | 4 to 6 months | 4 to 6 months | 4 to 6 months | 2.5 months in Autumn and |
| production | 5 months average | 5 months average | 5 months average | Winter |
| | | | | 1.5 months in Spring and |
| | | | | Summer |
| | | | | 2 months in average |
| Fields for the | It is performed in | It requires even fields | It requires even | It requires even fields |
| Productive | places chosen for | and good soil | fields and good soil | |
| Process | performing sewing activities | When soils stop being | When soils stop | |
| | | good, the productive system | being good, the productive | |
| | | is transferred to other fields | system is transferred to | |
| | | | other fields | |
| Sanitary | It has no barriers | Turfs produced in the | Turfs produced in the | None, because the substrate used |
| Barriers | | north of Eighth Region cannot | north of Eighth Region | is sawdust |
| | | be sent to the south because of | cannot be sent to the south | |
| | | the Sanitary Barrier of SAG | because of the Sanitary | |
| | | that avoids the transference of | Barrier of SAG that avoids | |
| | | soils from north to south | the transference of soils from | |
| | | | north to south | |
| Effects on the | None | It degrades soils with | It degrades soils with | None because the productive |
| environment | | agricultural potential by | agricultural potential by | system is based on soils where |
| | | performing 2.5 to 4 [cm] | performing 2.5 to 4 [cm] | greenhouses are implemented |
| | | depth cuts in a constant way | depth cuts in a constant | |
| | | | way | |

### Advantages of Prado Express

After analyzing the technical factors of alternative types for installation of grass, it is possible to determine that thanks to an innovating productive system, Prado Express has a unique set of characteristics that positions it as a product with strong competitive advantages:

The first set of advantages of Prado Express comes from the characteristics associated with its use as a grass installation:
a) Variability of measures: given the low weight and width of the substrate, Prado Express permits to handle variable sizes of carpets and the installation of an even lawn without separation marks.
b) High resistance: as the carpet maintains 100% of roots intact and forming a grid, Prado Express is highly resistant to ruptures both in the handling, installation and transport processes, even with high percentages of humidity present.
c) It does not add both weeds and black cutworm: thanks to its production in a controlled environment, Prado Express does not add weeds or transport black cutworm to the substrate layer.
d) Uniform distribution: thanks to its production in a controlled environment and the use of spray irrigation, Prado Express provides an even distribution of lawn without blank spaces.
e) Grass tone: thanks to its production in a controlled environment, Prado Express provides an even tone of green all year long.
f) Simple and Economic Installation Process: Since Prado Express maintains 100% of roots, the installation process is shorter because there is no need to improve the ground where the installation will be performed since the carpet does not need fields rich in organic matter. It also avoids the cost of improving the soil.
g) Shorter waiting periods for high transit: since Prado Express is a highly resistant carpet and maintains 100% of its roots in perfect shape, you can have a lawn ready for high transit conditions in no more than 2 weeks. This is a unique characteristic of Prado Express based on the integrity of the roots (they are never cut); therefore, it does not need recovery time and can be inserted rapidly in the ground where it is installed thanks to its Positive Geotropism properties.
h) Simple Maintenance: with Prado Express, maintenance does not require more care than a frequent watering and the optional use of a fertilizer.
i) Resistance to storing: The roots of Prado Express are capable of absorbing the humidity in the environment so it can support up to 10 days in storing conditions and maintain its color.
j) Easy Transport and Management: because of its low weight and high resistance of Prado Express, transport and handling are easy tasks both for mass transport or domestic transport.

The second set of advantages of Prado Express is associated to the productive system:

a) Innovative Productive Process: the productive system of Prado Express has been considered by Paiva & CIA Limitadaⁱⁱ as a process susceptible to be patented both in Chile and all over the world, because of its highly innovative level.
b) Simple Productive Process: the production process of Prado Express is simple because it does not need to improve the ground where the production will be performed.
c) Economical Productive Process: since the productive system of Prado Express does not require fields with good organic conditions, the cost for soils improvement can be avoided. Besides, as it is produced in greenhouses, the lost of seed is only 10%.
d) Production without seasonality: Prado Express can be produced in any time of the year maintaining the same conditions.
e) Short Productive Cycles: with Prado Express the production time is 1.5 months in spring and summer and 2.5 in autumn and winter permitting a rapid rotation and the possibility of 6 annual harvest as an average.
f) Mobility of Productive System: the production system of Prado Express permits Oasis Farm to install production centers in any part of the national territory.
g) Friendly with the Environment: The productive system Prado Express does not cause the degradation of soils with agricultural potential because it does not use soils where production is performed.

### DESCRIPTION OF DRAWINGS

To understand more clearly the method for the invention of cultivation, conservation, maintenance and installation of prado express in covered places, we will describe it based on drawings part of the description without it restricting the technical characteristics of this method, where:

FIG. 1 shows a view of one cut of the carpet where the plastic sheet can be observed and also the substrate in form of sawdust impregnating the already grown lawn.

FIG. 2 shows a view of the homogeneity and optimum quality of the growth of grass roots, free of impurities.

FIG. 3 shows a view of the rolled portion of lawn.

FIG. 4 shows a lower view of a portion of prado express where the impregnated substrate (sawdust) can be observed impregnated with the grass roots.

FIG. 5 shows a general view of the culture of prado express within a greenhouse.

FIG. 6 shows a view of the front lawn of a house without prado express.

FIG. 7 shows a view of FIG. 6, where prado express has been installed.

FIG. 8 shows a grid layout of the grass roots with the sawdust substrate and the plastic sheet, the parts that compose this invention.

FIG. 9 shows a lawn turf extracted through cuts to natural grasslawns or fields specially sown for this activity, using the current state of the art.

### DESCRIPTION OF INVENTION

The productive process of this invention for prado express includes the following six stages performed within 1.000 [m²] greenhouses provided with spray irrigation systems and has a soil covered by polyethylene sheets:

1. Prepare Field: surface must be level up and flatten for being then covered with plastic sheets (1) and then put a layer of substrate, preferably sawdust (2) not higher than 1 [cm] width acting as a substrate to fix the seed and uniformly distribute it, avoiding it to move during the productive cycle.

2. Sewing of lawn: then, lawn seeds are spread over the substrate (3) at a rate of 10 to 60 [Kg.] every 1,000 m², especially 34 [Kg.], and are fertilized with NPK fertilizer at a rate of 100 [Kg.] every 1,000 m².

3. Watering of lawn: after sewing, germination of the seed is expected by periodic spray irrigation, from top to bottom, as a maximum frequency of 2 or 3 times a day in spring and summer. In this stage, a spray irrigation system (fog type) is fundamental to obtain a uniform distributed lawn because it avoids that the impact of water drops over the substrate that can spread the seed and generate sections without grass in the carpet.

4. Maintenance of lawn: after the germination of the seed, maintenance is performed based on watering and the use of foliating fertilizer once a week. In this stage, plastic sheets over which the substrate and seeds have been placed gain importance because they avoid the roots to insert in the soil and force them to grow horizontally. As they develop, they also keep tangling and forming a grid that provides high resistance to the carpet.

5. Cut of lawn: after approximately a month after the germination of seeds, a first cut is performed to avoid losing the color of the grass and then it is fertilized again with the same amount of NPK fertilizer.

6. Lawn Harvest: when lawn reaches the harvest status, it is removed for sale. In this case, as the lawn carpet grew over the plastic sheet permitting the roots to tangle and providing an extreme durability, it is enough to cut it with scissors roll it and remove it.

Complementarily, it is worth to mention that the complete production process of the carpet takes 1.5 months in spring and summer and 2.5 months in autumn and winter.

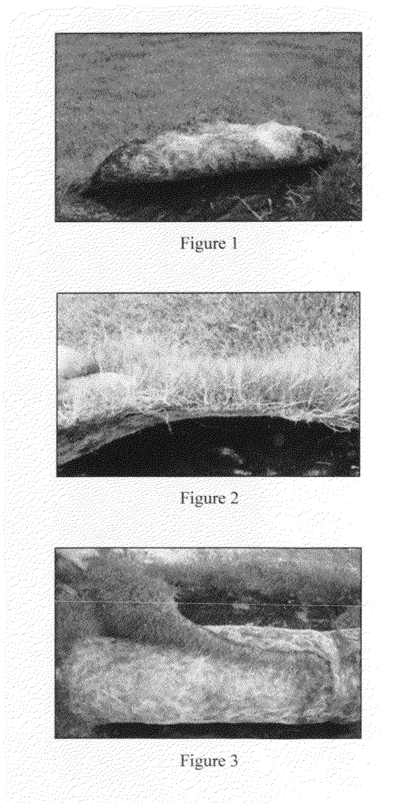

Prado express is supported by a 2 [cm] width and 3.5 [Kg] average weight by m² substrate layer of sawdust and maintains 100% of their roots in perfect shape. They are never damaged during the productive cycle which permits to lower considerably both time and cost of installation by not requiring fine quality fields or time for the recovery of roots, see FIGS. 1, 2 and 8.

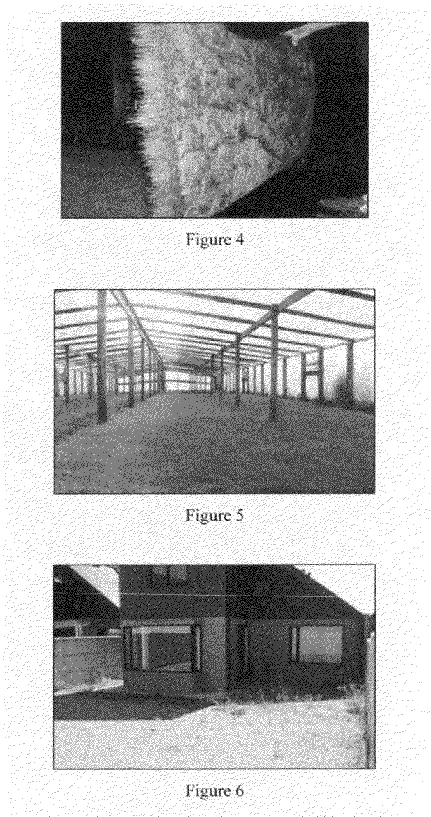

Prado express roots are tangled together forming a kind of grid that provides maximum resistance to the carpet and avoids ruptures at the moment of rolling, transport, installation and transit. See FIGS. 3, 4 and 8.

The production of prado express is performed using a substrate of sawdust over plastic sheets in a controlled environment system inside 1,000 [m²] greenhouses with spray irrigation systems and productive cycles of 1.5 months in spring and summer and 2.5 months in autumn and winter. See FIG. 5.

### Installation Process of Prado Express

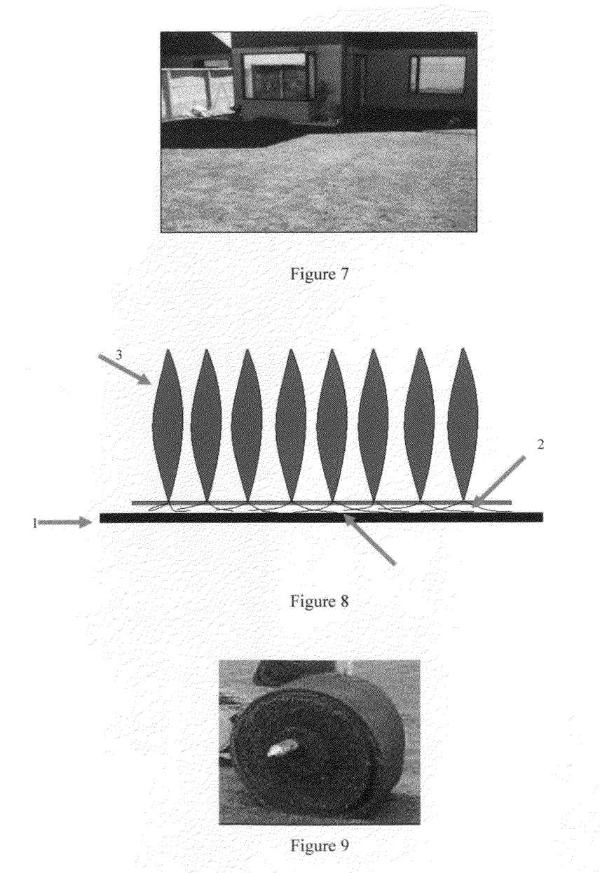

Once prado express is ready for use in private and public areas, the installation process is simple and economical, permitting to have a lawn ready for high traffic conditions in no more than two weeks. See FIGS. 6 and 7. Such installation process includes the following stages:

a) Level up: level the ground up, removing stones and all type of large size scrap.

b) Fertilizing process: it is recommended to spread a minimum portion of NPK fertilizer on the ground.

c) Installation: install Prado Express, just unrolling the carpet in the desired location.

d) Fertilizing process: it is recommended to spread a minimum portion of NPK fertilizer on the carpet.

e) Watering: Water frequently according to the season, considering a maximum of 2 a day in summer.

f) Cut: perform a first cut when the grass reaches 8 to 10 [cm] heights, leaving it at 4 to 5 [cm] heights and then fertilize again with NPK fertilizer.

The innovation of Prado Express lays on the development of a productive system that achieves a lawn carpet with 100% its roots intact which permits to have a lawn in high transit conditions in a period no longer than two weeks because its roots does not need a recovery time and are inserted rapidly in the ground where it is installed. Also, the ground where the installation is performed does not need a fine quality soil or special preparation further than level it up because being the roots complete they can adapt to any type of surface.

To achieve a lawn carpet with the mentioned characteristics, production is performed on plastic sheets which avoid the roots to insert in the ground and force them to grow horizontally with the roots of other seeds forming a grid together (FIG. 8), therefore they suffer no damage in the harvest and arrive intact to the installation place where they recover their vertical position and insert in the ground in an easy and rapid way.

1. A method for the cultivation, conservation and installation of prado express in greenhouses and closed facilities to obtain a natural lawn carpet of type Tehnisan Mix, in lower time and with the best quality, destined to cover private and public areas in a fast, easy and economic way, CHARACTERIZED for the cultivation, conservation, maintenance and installation processes including the following stages:
a) The surface of the soil in the greenhouse is covered with a water-proof surface such as a plastic sheet and then a layer of substrate is placed over it as sawdust not higher than 1 [cm] width acting as a substrate to fix the seed and uniformly distribute it, avoiding it to move during the productive cycle;
b) Then, lawn seeds are spread over the substrate at a rate of 10 to 60 [Kg.] every 1,000 m², and a fertilizer such as NPK at a rate of 100 [Kg.] every 1,000 m².
c) after sewing, germination of the seed is expected by periodic spray irrigation, from top to bottom, as a maximum frequency of 2 or 3 times a day in spring and summer;
d) after the germination of the seed, maintenance is performed based on watering and the use of foliating fertilizer (NPF) once a week;
e) After approximately a month after the germination of seeds, a first cut is performed to avoid losing the color of the grass and then it is fertilized again with the same amount of NPK fertilizer.
f) When lawn reaches the harvest status, it is removed for installation.

2. A method for the cultivation, conservation and installation of prado express in greenhouses and closed facilities according to claim 1, CHARACTERIZED for the installation and maintenance method of the lawn carpet including the following stages: a) First of all ground must be level up, removing stones and all type of large size scrap; b) Then irrigate with a minimum portion of NPK fertilizer on the ground;
c) Water frequently according to the season, considering a maximum of 2 a day in summer; and
d) Perform a first cut when the grass reaches 8 to 10 [cm] heights, leaving it at 4 to 5 [cm] heights.
